(19) United States
(12) Patent Application Publication
(10) Pub. No.: US 2025/0199835 A1
(43) Pub. Date: Jun. 19, 2025

(54) SIMULATING MULTI-CORE EMBEDDED SYSTEM FIRMWARE WITH FLAT ADDRESS SPACE

(71) Applicant: International Business Machines Corporation, Armonk, NY (US)

(72) Inventors: Sebastian HENSE, Boeblingen (DE); Christoph RAISCH, Gerlingen (DE); Luke HOPKINS, Peterborough, NH (US)

(21) Appl. No.: 18/538,850

(22) Filed: Dec. 13, 2023

(51) Int. Cl. G06F 9/455; G06F 3/06

(52) U.S. Cl. CPC G06F 9/45558; G06F 3/061; G06F 3/0665; G06F 3/0673; G06F 2009/4557; G06F 2009/45579; G06F 2009/45583

(57) ABSTRACT

Embodiments herein describe using a contiguous virtual memory address space to contain each component used to simulate firmware. That is, rather than using multiple virtual memory spaces, the embodiments herein use a contiguous virtual memory space to contain the software components in the simulation or emulation. This approach simplifies memory access and management regarding the different processes and hardware components. This also enables input output MMU (IOMMU) access from anywhere in the simulation system, thread local storage (TLS) for range isolation, and simplifies debugging and testing of firmware and other processes.

### BACKGROUND

The present invention relates to using a contiguous virtual address memory space when simulating firmware workloads.

Currently, when firmware workloads are simulated, a virtualization environment like Quick Emulator (QEMU) is used. QEMU emulates a computer's processor and provides a set of different hardware and device models for the machine, enabling it to run a variety of operating systems. Typically, QEMU simulates a real product (e.g., a computer system) using separate address spaces for different software components and both simulated and real hardware. Another, more light weight technology, is User-mode Linux (UML) (Linux® is the registered trademark of Linus Torvalds in the U.S. and other countries). UML implements the complete Linux kernel by using Linux kernel system calls from a user space process with an additional, simulated memory management unit (MMU) layer. Like with QEMU, processes and hardware are separated by multiple virtual memory address spaces.

### SUMMARY

Several embodiments can include a method, system, and computer program product that include establishing, in a simulation computing system, a single contiguous virtual memory space comprising a FW module, a first instance of the FW module, a HW simulation model that models a HW component operated by the FW module, and a kernel bridge library that permits the HW simulation model to communicate with hardware in the computing system; and simulating workloads on the FW module and the first instance of the FW module using the contiguous virtual memory space.

### BRIEF DESCRIPTION OF THE DRAWINGS

FIG. 1 illustrates a computing environment, according to one embodiment.

FIG. 2 illustrates a virtual memory space in a real system, according to one embodiment.

FIG. 3 illustrates a virtual memory space in a system simulating the real system in FIG. 2, according to one embodiment.

FIG. 4 illustrates a virtual memory space in a system simulating the real system in FIG. 2, according to one embodiment.

FIG. 5 is a flowchart for establishing a simulation system, according to one embodiment.

FIG. 6 is a flowchart for simulating workloads on FW modules, according to one embodiment.

### DETAILED DESCRIPTION

Embodiments herein describe using a contiguous virtual memory address space to contain each component used to simulate firmware. That is, rather than using multiple virtual memory spaces (e.g., one for each software component) like in QEMU and UML, the embodiments herein use one virtual memory space to contain the software components in the simulation or emulation. This approach simplifies memory access and management regarding the different processes and hardware components. This also enables input/output MMU (IOMMU) access from anywhere in the simulation system, thread local storage (TLS) for range isolation, and simplifies debugging and testing of firmware and other processes.

In one embodiment, a method, system, or computer program product includes establishing, in a simulation computing system, a single contiguous virtual memory space comprising a FW module, a first instance of the FW module, a HW simulation model that models a HW component operated by the FW module, and a kernel bridge library that permits the HW simulation model to communicate with hardware in the computing system; and simulating workloads on the FW module and the first instance of the FW module using the contiguous virtual memory space. Advantageously, this approach simplifies memory access and management regarding the different processes and hardware components.

In an additional embodiment, the contiguous virtual memory space comprises multiple FW modules and multiple instances of the multiple FW modules, wherein Executable and Linkable Format (ELF)-Thread Local Storage (TLS) is used to isolate data in the multiple FW modules and the multiple instances from each other within the contiguous virtual memory space. Advantageously, using ELF-TLS enables better data security and data isolation between the FW modules.

In an additional embodiment, which can include any of the embodiments above, communication between the FW module, the HW simulation model and the kernel bridge library can occur using an input/output memory management unit (IOMMU). The IOMMU enables a virtual-to-PCI address translation which facilitates communication between the FW modules and the hardware in the simulation system Advantageously, this simples the simulation setup since address translation does not have to occur between these components.

In an additional embodiment, which can include any of the embodiments above, establishing the contiguous virtual memory space comprises loading a common runtime into the contiguous virtual memory space where the common runtime configures data areas and stacks for itself and the first instance of the FW module. Advantageously, the common runtime can establish multiple instances of the FW modules in the virtual memory space.

In an additional embodiment, which can include any of the embodiments above, the contiguous virtual memory space is within host user space in the computer simulation system, where the kernel bridge library permits the HW simulation models in the host user space to communicate with a host kernel that is in host kernel space in the computer simulation system. Adventurously, the kernel bridge library permits the HW simulation models to leverage the physical (actual) hardware in the computer simulation system and the host kernel.

In an additional embodiment, which can include any of the embodiments above, establishing the contiguous virtual memory space comprises linking code components that should be present at firmware startup time into an ELF-format executable, where ELF-TLS is used to specify the first instance of the FW module. Advantageously, in contrast to prior solutions where different components (e.g., the FW modules and their instances) are loaded dynamically, in this example the components are loaded into one executable.

In an additional embodiment, which can include the previous embodiment, establishing the contiguous virtual memory space comprise switching a host processor in the simulation computing system to user mode and calling an ELF-executable entry point provided in the ELF-format executable. Advantageously, this completes the last step of a kernel start process.

In an additional embodiment, which can include any of the embodiments above, the virtual memory space comprises a second instance of the FW module, where the first instance of the FW module corresponds to a first HW device and the second instance of the FW module corresponds to a second HW device that is a same type of the first HW device. Advantageously, one FW module can be used to create two instances of the FW module, which means the FW module only has to be stored once in the virtual memory, but can be used to spin up any number of instances for any number of HW devices in the system.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as emulator 195 which establishes an emulation or simulation environment for simulating firmware corresponding to a real, physical system. In addition to the emulator 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and emulator 195, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

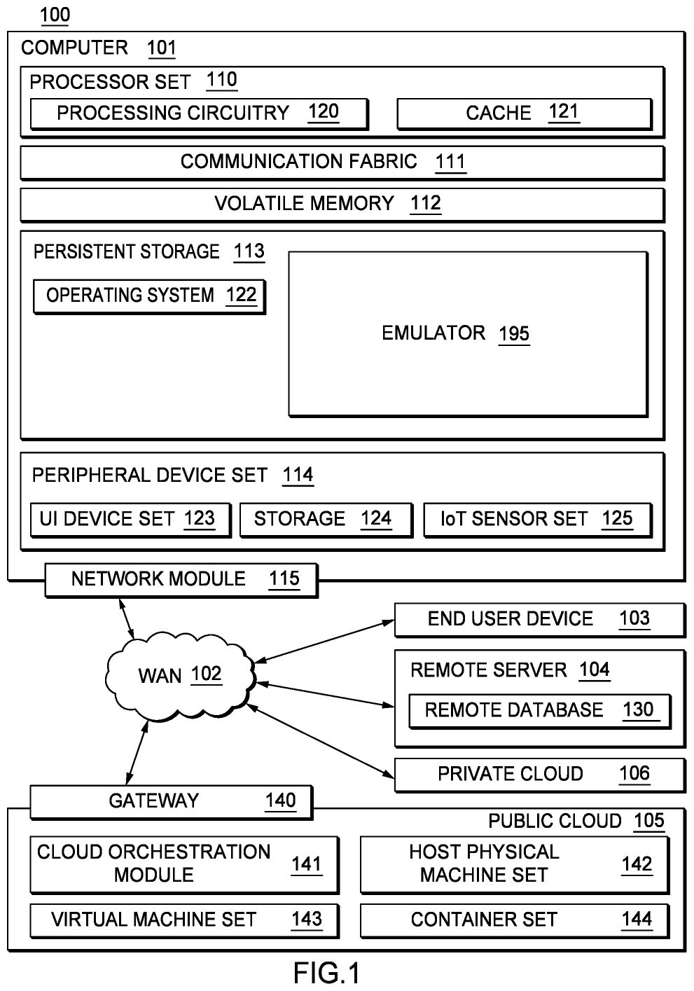

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in emulator 195 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in emulator 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

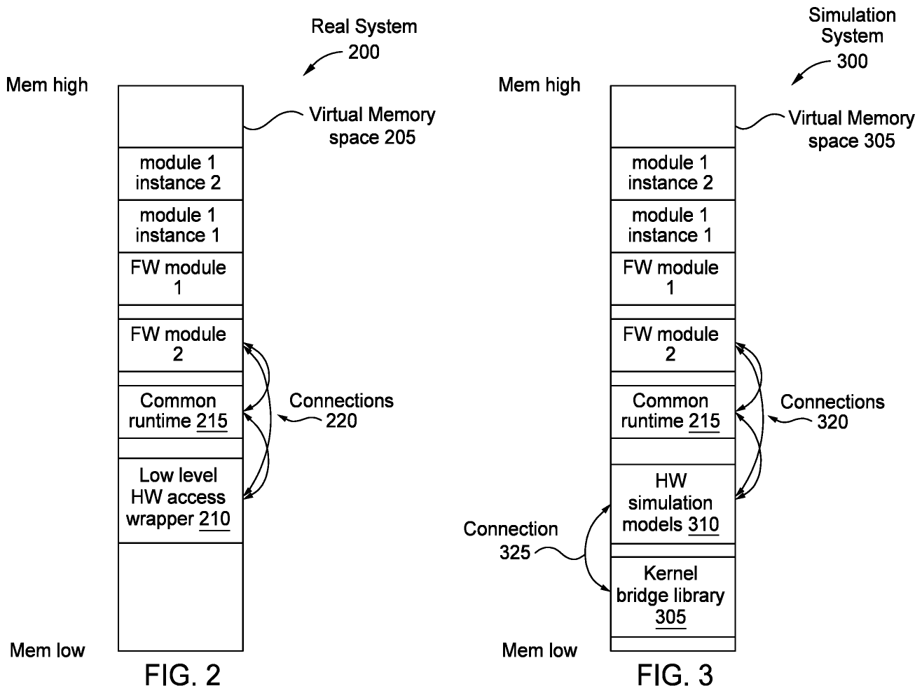

FIG. 2 illustrates a virtual memory space 205 in a real system 200, according to one embodiment. The real system 200 can be a computer system that has any number of software or hardware components. For example, the real system 200 can include Peripheral Component Interconnect Express (PCIe) devices, network interface cards, central processing units (CPUs), graphics processing units (GPUs), hardware accelerators, and the like. The virtual memory space 205 illustrates allocating different portions of memory to the software or hardware components in the real system 200.

In this example, the virtual memory space 205 includes low-level hardware (HW) access wrapper 210, a common runtime 215, firmware (FW) module 1, FW module 2, module 1 instance 2, and module 1 instance 1. The HW access wrapper 210 provides space in the virtual memory space 205 for the FW modules and the module instances to access the hardware of the real system 200, which can include PCIe devices, network interface cards/controllers, virtual function input/output (VFIO) devices, and the like. These hardware components are not shown in FIG. 2.

The common runtime 215 can include application programming interfaces (APIs) and libraries. In one embodiment, the common runtime 215 configures data areas and stacks for itself and the module instances. For example, each FW module may correspond to firmware for a hardware component in the real system 100. For example, the FW module 1 may include firmware code for a network interface card, while the FW module 2 includes code for a different hardware component. The real system 200, however, can include multiple network interface cards. While the FW module 1 includes the program code for the card, the common runtime 115 can spin up a different instance for each of the network interface cards in the real system 200. In this example, the real system 100 may include two of the network interface cards where module 1 instance 1 stores the data for one of the cards and module 1 instance 2 stores the data for the other card. As discussed in more detail below, TLS can be used to identify data instances of a FW module, which can help with data isolation between the two network interface cards. In this manner, each of the FW modules can be associated with any number of instances, depending on the number of corresponding hardware components in the real system 200.

FIG. 2 also illustrates connections 220 between the FW modules, the common runtime 215, and the low level HW access wrapper 210. These connections can be made using common APIs (c-APIs).

Notably, FIG. 2 illustrates that the real system 200 (e.g., a physical computing system) includes a contiguous virtual memory space 205 (extending from a low memory address to a high memory address) that is subdivided among different components. An IOMMU can be used to translate between virtual addresses in the virtual memory space 205 and PCI/IO addresses. By using a TLS mechanism, the real system 200 has a single virtual memory space 205 rather than having different virtual memory spaces for each component—e.g., a virtual memory space for FW module 1, a different virtual memory space for FW module 2, a different virtual memory space for module 1 instance 1, a different virtual memory space for module 1 instance 2, and so forth.

FIG. 3 illustrates a virtual memory space 350 in a system 300 simulating the real system in FIG. 2, according to one embodiment. That is, the simulation system 300 (also referred to as a simulation computing system) can be executed on a computing device such as described in FIG. 1 to simulate the functions of the real system 200, such as simulating firmware workloads of the real system 200. Advantageously, FIG. 3 illustrates that the virtual memory space 305 of the simulation system 300 has a similar structure as the virtual memory space 205 of the real system 200. That is, the virtual memory space 305 is also contiguous, and is a single (or shared) virtual memory space. In contrast, other simulation systems such as QEMU and UML separate processes and hardware into their own virtual memory address spaces. For example, the FW modules and the instances may be in different address spaces. Those simulation systems may have a different virtual address space for each user application and UML kernel. This means any communication between the different virtual address space goes through a host kernel where an IOMMU performs address translation. Further, modern systems use IOMMUs to separate PCI devices from each other. This security measure is also reflected in VFIO and it is only possible to map a VFIO group, which can include multiple devices, into one virtual address space. In an environment like UML, it is only possible to make VFIO devices available to the host kernel but processes are not able to use them without system calls to the host kernel. However, the embodiments herein avoid these disadvantages by using a contiguous virtual address space 305, like the real system 200 shown in FIG. 2.

The virtual memory space 305 includes a kernel bridge library 305, HW simulation models 310, a common runtime 315, FW modules, and module instances. The common runtime 315, the FW modules, and the module instances can be the same as described in FIG. 2. For example, the simulation system 300 can be used to test the FW modules and the module instances to identify and debug problems before these components are put in a product that includes the real system 200.

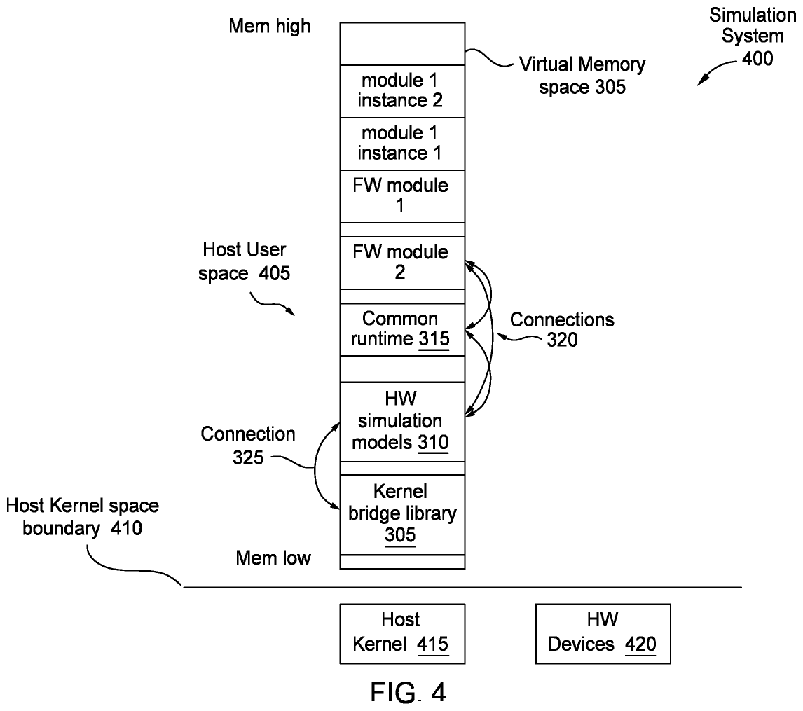

In one embodiment, the kernel bridge library 305 implements a set of system calls which are used to initialize and manage resources handled by a host kernel (which will be discussed in FIG. 4). The kernel bridge library 305 is added (relative to the real system) to permit the HW simulation models 310 to communicate with the host kernel. Put differently, the kernel bridge library 305 permits the HW simulation models 310 that are simulating HW modules that will be used in the real system to communicate with the HW executing the simulation system 300.

The HW simulation models 310 can be high level models (HIMOs) that simulate the HW that will be used in the real system. The HW simulation models 310 permit the simulation system 300 to test and simulate the workloads on the FW modules. The HW simulation models 310 model the HW that is run by the FW modules in the real system. For example, one of the HW simulation models 310 may model a network interface card while the FW module 1 is the firmware for operating that network interface card. The module 1 instance 1 and the module 1 instance 2 can represent a real system that has two different instances for operating two physical network interface cards in the real system.

Like in FIG. 2, a FW module can be responsible for any number of module instances. The module instances can be thought of as user applications. Instead of duplicating the program card for the FW module for each instance of that module, Executable and Linkable Format (ELF)-TLS can be used to manage different instances that represent different applications or different hardware in the real system.

ELF-TLS was originally intended to separate different ELF threads. However, in the embodiments herein, ELF-TLS is used to identify different instances of a FW module so the data of each instance can be isolated. Thus, ELF-TLS can be used in both the virtual memory space of the real system in FIG. 2 and the virtual memory space 305 of the simulation system 300 in FIG. 3 to isolate the different module instances, even though these instances are in the same virtual space.

FIG. 3 also illustrates connections 320 between the FW modules, the common runtime 315, and the HW simulation models 310. These connections 320 can be made using common APIs (c-APIs). FIG. 3 also illustrates connection 325 between the HW simulation models 310. This permits the HW simulation models 310 to communicate with the kernel bridge library 305 which in turn communicates with the host kernel of the simulation system 300. The host kernel is shown in FIG. 4. Notably, because the FW modules, common runtime 315, HW simulation models 310, and the kernel bridge library 305 are in the same virtual memory space 305, communication between these components does not require the use of virtual-to-physical address translation. That is, these components can communicate using an IOMMU in the simulation system 300 which enables virtual-to-PCI address translation.

FIG. 4 illustrates a virtual memory space 305 in a system simulating the real system in FIG. 2, according to one embodiment. In addition to including the virtual memory space 305, the simulation system 400 (also referred to as a simulation computing system) includes a host kernel space boundary 410 that separates a host user space 405 (which includes the virtual memory space 305) from the host kernel 415 and HW devices 420, which are in a host kernel space. The HW devices 420 can include VFIO devices, PCIe devices, network interface cards/controllers, and the like.

As mentioned above, the kernel bridging library 305 can implement a set of system calls which are used to initialize and manage resources handled by the host kernel 415. The embodiments herein unify multiple address spaces into one contiguous address space 305 in the host user space 405, and as such, mapping VFIO groups is not needed. The FW modules can use the kernel bridging library 305 to make the VFIO available and since each module instance works within the same address space 305 it can use simple c-calls to access resources of the VFIO device (e.g., a HW device 420) in the host kernel space.

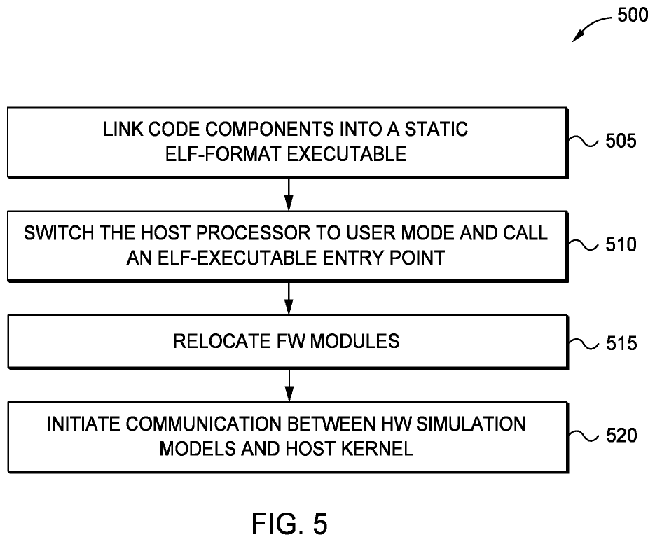

FIG. 5 is a flowchart of a method 500 for establishing a simulation system, according to one embodiment. In one embodiment, the method 500 can be used to configure the virtual memory space shown in FIGS. 3 and 4 for simulating firmware.

At block 505, an emulator links code components that should be present at firmware startup time into an ELF-format executable. In contrast to prior solutions where different components (e.g., the FW modules and their instances) are loaded dynamically, in this example the components are loaded into one executable. Loading the components into one executable aids or enables the use of a contiguous virtual memory space. The ELF-format executable can be run in the virtual address space.

An advantage of using ELF format is it can separate and isolate the FW modules and their instances from each other. This provides the advantage of memory safety for the FW modules and the module instances, without having to establish different virtual memory address spaces for each FW module and instance as done in previous solutions. In one embodiment, ELF-TLS is used to specify the module instances. In one embodiment, the executable is a static ELF-format executable.

The ELF-format executable can be loaded, relocated, and started by a host kernel ELF loader. The ELF loader can perform an suitable executable start process in order to load the executable.

At block 510, when started, the kernel acts on content of the ELF-format executable and switches the host processor (e.g., CPU) to user mode and calls an ELF-executable entry point. In one embodiment, switching the host processor to user mode is the last step of the kernel start processes.

In one embodiment, the ELF-executable entry point is stored in a header of the ELF executable. Further, in method 500, the ELF-executable entry point is an entry point of the common runtime (e.g., the common runtime 315 in FIGS. 3 and 4).

At block 515, the common runtime relocates the ELF-TLS runtime FW modules and configures data areas and stacks for instances of the FW modules (e.g., module 1 instance 1 and module 1 instance 2 illustrates in FIGS. 3 and 4). For example, the FW modules may be relocated by another FW module within the virtual address space. In addition, the common runtime can configure data areas and stacks for its own use. In one embodiment, ELF-TLS specifies a FW module, such as the common runtime 315.

At block 520, the kernel library bridge initiates communication between the HW simulation models and the host kernel. Referring to FIG. 2, in the real system 200, the common runtime 215 configures start addresses for other system cores through the low-level HW access wrapper 210 which communicates with HW resources (not shown in FIG. 2). However, in the simulation system 300 the low-level HW access wrapper is replaced by the HW simulation models which interface to the host kernel through the kernel library bridge. In one embodiment, the kernel library bridge uses an additional thread that uses the same memory space as the thread executing the common runtime.

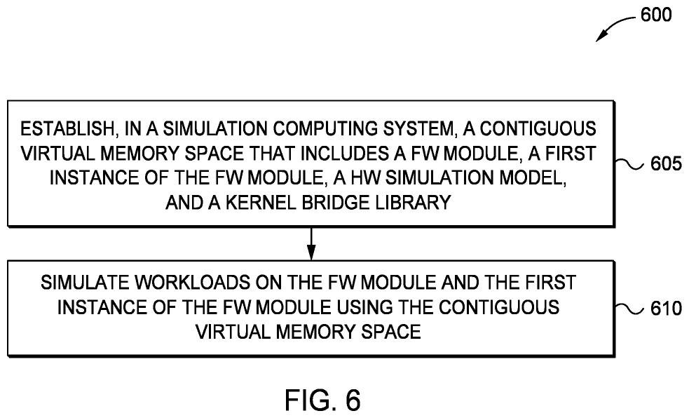

FIG. 6 is a flowchart of a method 600 for simulating workloads on FW modules. That is, the method 600 can be used to simulate and test firmware using HW simulation models before the firmware modules are deployed in a real computing system.

At block 605, a simulation computing system establishes a contiguous virtual memory space that includes a FW module, a first instance of the FW module, a HW simulation model, and a kernel bridge library. In one embodiment, establishing the virtual memory space is performed using the method 500. Put differently, the method 500 is one example of establishing a contiguous virtual memory space that includes one or more FW modules, one or more instances of those FW modules, HW simulation models that correspond to the FW modules, and the kernel bridge library to permit the HW simulation models to communicate with the physical hardware in the simulation computing system. Examples of the virtual memory space and the simulation computing system are shown in FIGS. 3 and 4.

At block 610, the simulation computing system simulates workloads on the FW module and the first instance of the FW module using the contiguous virtual memory space. Once the components in the virtual memory space are established, the simulation computing system can use the module instances, the HW simulation models, and the kernel bridge layer to simulate the workload on the FW modules as if they were in the real system. This simulation permits a developer to test and debug the code in the FW modules before being used in a real system (e.g., a customer's deployment).

While the foregoing is directed to embodiments of the present invention, other and further embodiments of the invention may be devised without departing from the basic scope thereof, and the scope thereof is determined by the claims that follow.

What is claimed is:

1. A method comprising:
establishing, in a simulation computing system, a single contiguous virtual memory space comprising a firmware (FW) module, a first instance of the FW module, a hardware (HW) simulation model that models a HW component operated by the FW module, and a kernel bridge library that permits the HW simulation model to communicate with hardware in the computing system; and
simulating workloads on the FW module and the first instance of the FW module using the contiguous virtual memory space.

2. The method of claim 1, wherein the contiguous virtual memory space comprises multiple FW modules and multiple instances of the multiple FW modules, wherein Executable and Linkable Format (ELF)-Thread Local Storage (TLS) is used to isolate data in the multiple FW modules and the multiple instances from each other within the contiguous virtual memory space.

3. The method of claim 1, wherein communication between the FW module, the HW simulation model and the kernel bridge library occurs using an input/output memory management unit (IOMMU).

4. The method of claim 1, wherein establishing the contiguous virtual memory space comprises loading a common runtime into the contiguous virtual memory space, wherein the common runtime configures data areas and stacks for itself and the first instance of the FW module.

5. The method of claim 1, wherein the contiguous virtual memory space is within host user space in the computer simulation system, wherein the kernel bridge library permits the HW simulation models in the host user space to communicate with a host kernel that is in host kernel space in the computer simulation system.

6. The method of claim 1, wherein establishing the contiguous virtual memory space comprises:
linking code components that should be present at firmware startup time into an ELF-format executable, wherein ELF-TLS is used to specify the first instance of the FW module.

7. The method of claim 5, wherein establishing the contiguous virtual memory space comprises:
switching a host processor in the simulation computing system to user mode and calling an ELF-executable entry point provided in the ELF-format executable.

8. The method of claim 1, wherein the virtual memory space comprises a second instance of the FW module, wherein the first instance of the FW module corresponds to a first HW device and the second instance of the FW module corresponds to a second HW device that is a same type of the first HW device.

9. A system, comprising:
a processor; and
memory, wherein the memory includes computer code which, when executed by the processor, performs an operation, the operation comprising:
establishing, in a simulation computing system, a single contiguous virtual memory space comprising a FW module, a first instance of the FW module, a HW simulation model that models a HW component operated by the FW module, and a kernel bridge library that permits the HW simulation model to communicate with hardware in the computing system; and
simulating workloads on the FW module and the first instance of the FW module using the contiguous virtual memory space.

10. The system of claim 9, wherein the contiguous virtual memory space comprises multiple FW modules and multiple instances of the multiple FW modules, wherein ELF-TLS is used to isolate data in the multiple FW modules and the multiple instances from each other within the contiguous virtual memory space.

11. The system of claim 9, wherein communication between the FW module, the HW simulation model and the kernel bridge library occurs using an IOMMU.

12. The system of claim 9, wherein establishing the contiguous virtual memory space comprises loading a common runtime into the contiguous virtual memory space, wherein the common runtime configures data areas and stacks for itself and the first instance of the FW module.

13. The system of claim 9, wherein the contiguous virtual memory space is within host user space in the computer simulation system, wherein the kernel bridge library permits the HW simulation models in the host user space to communicate with a host kernel that is in host kernel space in the computer simulation system.

14. The system of claim 9, wherein establishing the contiguous virtual memory space comprises:
linking code components that should be present at firmware startup time into an ELF-format executable, wherein ELF-TLS is used to specify the first instance of the FW module; and
switching a host processor in the simulation computing system to user mode and calling an ELF-executable entry point provided in the ELF-format executable.

15. A computer program product for comprising:
a computer-readable storage medium having computer-readable program code embodied therewith, the computer-readable program code executable by one or more computer processors to perform an operation, the operation comprising:
establishing, in a simulation computing system, a single contiguous virtual memory space comprising a FW module, a first instance of the FW module, a HW simulation model that models a HW component operated by the FW module, and a kernel bridge library that permits the HW simulation model to communicate with hardware in the computing system; and
simulating workloads on the FW module and the first instance of the FW module using the contiguous virtual memory space.

16. The computer program product of claim 15, wherein the contiguous virtual memory space comprises multiple FW modules and multiple instances of the multiple FW modules, wherein ELF-TLS is used to isolate data in the multiple FW modules and the multiple instances from each other within the contiguous virtual memory space.

17. The computer program product of claim 15, wherein communication between the FW module, the HW simulation model and the kernel bridge library occurs using an IOMMU.

18. The computer program product of claim 15, wherein establishing the contiguous virtual memory space comprises loading a common runtime into the contiguous virtual memory space, wherein the common runtime configures data areas and stacks for itself and the first instance of the FW module.

19. The computer program product of claim 15, wherein the contiguous virtual memory space is within host user space in the computer simulation system, wherein the kernel bridge library permits the HW simulation models in the host user space to communicate with a host kernel that is in host kernel space in the computer simulation system.

20. The computer program product of claim 15, wherein establishing the contiguous virtual memory space comprises:
linking code components that should be present at firmware startup time into an ELF-format executable, wherein ELF-TLS is used to specify the first instance of the FW module; and
switching a host processor in the simulation computing system to user mode and calling an ELF-executable entry point provided in the ELF-format executable.
